(19) United States
(12) Patent Application Publication
(10) Pub. No.: US 2011/0012994 A1
(43) Pub. Date: Jan. 20, 2011

(54) METHOD AND APPARATUS FOR MULTI-VIEW VIDEO CODING AND DECODING

(75) Inventors: Min-Woo PARK, Suwon-si (KR); Dae-Sung CHO, Seoul (KR); Woong-Il CHOI, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/838,957

(22) Filed: Jul. 19, 2010

(30) Foreign Application Priority Data
Jul. 17, 2009 (KR) 10-2009-0065615

(51) Int. Cl. H04N 7/32; H04N 13/00

(52) U.S. Cl. 348/43; 375/240.12; 375/240.16; 348/E13.001; 375/E07.243

(57) ABSTRACT

A multi-view video coding method and apparatus and a multi-view video decoding method and apparatus for providing a multi-view video service are provided. The multi-view video coding method includes: coding a base layer picture using an arbitrary video codec; generating a prediction picture using at least one of a reconstructed base layer picture and a reconstructed layer picture having a different view from that of the base layer picture; and residual-coding a layer picture having the different view using the prediction picture.

### CROSS-REFERENCE TO RELATED APPLICATION

This application claims priority from Korean Patent Application No. 10-2009-0065615, filed in the Korean Intellectual Property Office on Jul. 17, 2009, the entire disclosure of which is hereby incorporated in its entirety by reference.

### BACKGROUND

1. Field

Apparatuses and methods consistent with exemplary embodiments relate generally to an apparatus and method for coding and decoding video sequences, and in particular, to a method and apparatus for coding and decoding multi-view video sequences such as stereoscopic video sequences in a layered coding structure, or a hierarchical coding structure.

2. Description of Related Art

Typical examples of related art three-dimensional (3D) video coding methods include Multi-view Profile (MVP) based on MPEG-2 Part 2 Video (hereinafter, MPEG-2 MVP), and Multi-view Video Coding (MVC) based on H.264 (MPEG-4 AVC) Amendment 4 (hereinafter, H.264 MVC).

The MPEG-2 MVP method for coding stereoscopic video performs video coding based on a main profile and a scalable profile of MPEG-2 using inter-view redundancy of video. Furthermore, the H.264 MVC method for coding multi-view video performs video coding based on H.264 using the inter-view redundancy of video.

Since 3D video sequences coded using the existing MPEG-2 MVP and H.264 MVC are compatible only with MPEG-2 and H.264, respectively, MPEG-2 MVP and H.264 MVC based 3D video cannot be used in a system that is not based on MPEG-2 or H.264. For example, a system using various other codecs, such as Digital Cinema, should be able to additionally provide 3D video services while being compatible with each of the codecs used. However, since MPEG-2 MVP and H.264 MVC are less compatible with systems using other codecs, a new approach is required to easily provide 3D video services even in the systems using codecs other than MPEG-2 MVP or H.264 MVC.

### SUMMARY

Aspects of exemplary embodiments provide a video coding and decoding method and apparatus for providing multi-view video services while providing compatibility with various video codecs.

Aspects of exemplary embodiments also provide a video coding and decoding method and apparatus for providing multi-view video services based on a layered coding and decoding method.

According to an aspect of an exemplary embodiment, there is provided a multi-view video coding method for providing a multi-view video service, the method including: coding a base layer picture using an arbitrary video codec; generating a prediction picture using at least one of a reconstructed base layer picture, which is reconstructed from the coded base layer picture, and a reconstructed layer picture corresponding to a view different from a view of the base layer picture; and residual-coding a layer picture corresponding to the different view using the generated prediction picture.

According to an aspect of another exemplary embodiment, there is provided a multi-view video coding apparatus for providing a multi-view video service, the apparatus including: a base layer coder which codes a base layer picture using an arbitrary video codec; a view converter which generates a prediction picture using at least one of a reconstructed base layer picture, which is reconstructed from the coded base layer picture, and a reconstructed layer picture corresponding to a view different from a view of the base layer picture; and a residual coder which residual-codes a layer picture corresponding to the different view using the generated prediction picture.

According to an aspect of another exemplary embodiment, there is provided a multi-view video decoding method for providing a multi-view video service, the method including: reconstructing a base layer picture using an arbitrary video codec; generating a prediction picture using at least one of the reconstructed base layer picture and a reconstructed layer picture corresponding to a view different from a view of the base layer picture; and reconstructing a layer picture corresponding to the different view using a residual-decoded layer picture and the generated prediction picture.

According to an aspect of another exemplary embodiment, there is provided a multi-view video decoding apparatus for providing a multi-view video service, the apparatus including: reconstructing a base layer picture using an arbitrary video codec; generating a prediction picture using at least one of the reconstructed base layer picture and a reconstructed layer picture corresponding to a view different from a view of the base layer picture; and reconstructing a layer picture corresponding to the different view using a residual-decoded layer picture and the generated prediction picture.

According to an aspect of another exemplary embodiment, there is provided a multi-view video providing system including: a multi-view video coding apparatus, comprising: a base layer coder which codes a base layer picture using an arbitrary video codec, a view converter which generates a prediction picture using at least one of a reconstructed base layer picture, which is reconstructed from the coded base layer picture, and a reconstructed layer picture corresponding to a view different from a view of the base layer picture, a residual coder which residual-codes a layer picture corresponding to the different view using the generated prediction picture, and a multiplexer which multiplexes the coded base layer picture and the residual-coded layer picture into a bitstream, and outputs the bitstream; and a multi-view video decoding apparatus comprising: a demultiplexer which receives and demultiplexes the output bitstream into a base layer bitstream and a layer bitstream, a base layer decoder which reconstructs the base layer picture from the base layer bitstream using a video codec corresponding to the arbitrary video codec, a view converter which generates the prediction picture using at least one of the reconstructed base layer picture and the reconstructed layer picture corresponding to the different view, a residual decoder which residual-decodes the layer bitstream to output a residual-decoded layer picture, and a combiner which reconstructs the layer picture corresponding to the different view by adding the generated prediction picture to the residual-decoded layer picture.

### BRIEF DESCRIPTION OF THE DRAWINGS

The above and other aspects will be more apparent from the following description taken in conjunction with the accompanying drawings, in which:

FIG. 1 is a block diagram showing a structure of a multi-view video coder according to an exemplary embodiment;

FIG. 2 is a block diagram showing a structure of a view converter in a multi-view video coder according to an exemplary embodiment;

FIG. 3 is a flowchart showing a multi-view video coding method according to an exemplary embodiment;

FIG. 4 is a flowchart showing a view conversion method performed in a multi-view video coder according to an exemplary embodiment;

FIG. 5 is a block diagram showing a structure of a multi-view video decoder according to an exemplary embodiment;

FIG. 6 is a block diagram showing a structure of a view converter in a multi-view video decoder according to an exemplary embodiment;

FIG. 7 is a flowchart showing a multi-view video decoding method according to an exemplary embodiment;

FIG. 8 is a flowchart showing a view conversion method performed in a multi-view video decoder according to an exemplary embodiment;

FIG. 9 is a block diagram showing an exemplary structure of a multi-view video coder with N enhancement layers according to another exemplary embodiment; and

FIG. 10 is a block diagram showing an exemplary structure of a multi-view video decoder with N enhancement layers according to another exemplary embodiment.

### DETAILED DESCRIPTION OF EXEMPLARY EMBODIMENTS

Exemplary embodiments will now be described in detail with reference to the accompanying drawings. In the following description, specific details such as detailed configuration and components are merely provided to assist the overall understanding of exemplary embodiments. In addition, descriptions of well-known functions and constructions are omitted for clarity and conciseness. Furthermore, in the drawings, like reference numerals refer to the same elements throughout. Expressions such as “at least one of,” when preceding a list of elements, modify the entire list of elements and do not modify the individual elements of the list.

In the following description, codecs such as H.264 and VC-1 are introduced as exemplary types of codecs, but theses exemplary codecs are merely provided for a better understanding of exemplary embodiments, and are not intended to limit the scope of the exemplary embodiments.

An exemplary embodiment provides a hierarchical structure of a video coder/decoder to provide multi-view video services such as three-dimensional (3D) video services while maintaining compatibility with any existing codec used for video coding/decoding.

A video coder/decoder designed in a layered coding/decoding structure according to an exemplary embodiment codes and decodes multi-view video including one base layer picture and at least one enhancement layer picture. The base layer picture as used herein refers to pictures which are compression-coded based on an existing scheme using existing video codecs such as VC-1 and H.264. The enhancement layer picture refers to pictures which are obtained by residual-coding pictures that have been view-converted using at least one of a base layer picture of one view and an enhancement layer picture of a view different from that of the base layer, regardless of the type of the video codec used in the base layer.

It should be noted that in the present disclosure, the enhancement layer picture refers to pictures having different views from that of the base layer picture.

Furthermore, in an exemplary embodiment, if the base layer picture is a left-view picture, the enhancement layer picture may be a right-view picture. Conversely, if the base layer picture is a right-view picture, the enhancement layer picture may be a left-view picture. If the enhancement layer picture is one in number, the base layer picture and the enhancement layer picture are considered as left/right-view pictures, respectively, for convenience of description, though it is understood that the base layer picture and the enhancement layer picture may be pictures of various views such as front/rear-view pictures and top/bottom-view pictures. Therefore, the enhancement layer picture may be construed as a layer picture having a view different from that of the base layer picture. In the present disclosure, the layer picture having a different view and the enhancement layer picture may be construed to be the same. If the enhancement layer picture is plural in number, pictures of various views (such as front/rear-view pictures, top/bottom-view pictures, etc.) may be provided as multi-view video by using the base layer picture and the multiple enhancement layer pictures.

Furthermore, according to an exemplary embodiment, an enhancement layer picture is generated by coding a residual picture. The residual picture is defined as a result of coding picture data obtained from a difference between an enhancement layer's input picture and a prediction picture generated by view conversion according to an exemplary embodiment. The prediction picture is generated using at least one of a reconstructed base layer picture and a reconstructed enhancement layer picture.

If the base layer's input picture is assumed as “view 0” and the enhancement layer's input picture is assumed as “view 1,” the reconstructed base layer picture refers to a currently reconstructed base layer picture that is reconstructed by coding the input picture “view 0” by an arbitrary existing video codec, and then decoding the coded picture. The reconstructed enhancement layer picture used for generation of the prediction picture refers to a previously reconstructed enhancement layer picture generated by a previous residual picture to a previous prediction picture. Furthermore, if the enhancement layer is plural in number, the reconstructed enhancement layer picture refers to a currently reconstructed enhancement layer picture, which is generated by reconstructing the currently coded residual picture in another enhancement layer of a view different from that of the enhancement layer. View conversion for generating the prediction picture will be described in detail later.

A multi-view video coder according to an exemplary embodiment outputs a base layer picture of one view in a bitstream by coding a base layer's input picture using an arbitrary video codec, and outputs an enhancement layer picture having a view different from that of the base layer picture in a bitstream by performing residual coding on an enhancement layer's input picture using a prediction picture generated by the view conversion.

A multi-view video decoder according to an exemplary embodiment reconstructs a base layer picture of one view by decoding a coded base layer picture of the view using the arbitrary video codec, and residual-decodes a coded enhancement layer picture of a different view from that of the base layer picture and reconstructs the enhancement layer picture having the different view using a prediction picture generated by the view conversion.

A two-dimensional (2D) picture of one view may be reconstructed by taking a base layer's bitstream from the bitstream and decoding the base layer's bitstream, and an enhancement layer picture having a different view in, for example, a 3D picture may be reconstructed by decoding the base layer's bitstream and then combining a prediction picture generated by performing view conversion according to an exemplary embodiment with a residual picture generated by decoding an enhancement layer's bitstream.

A structure and operation of a multi-view video coder according to an exemplary embodiment will now be described in detail. For convenience of description, the exemplary embodiment described below uses both a reconstructed current base layer picture and a reconstructed previous enhancement layer picture during view conversion, and the number of enhancement layers is 1. However, it is understood that another exemplary embodiment is not limited thereto.

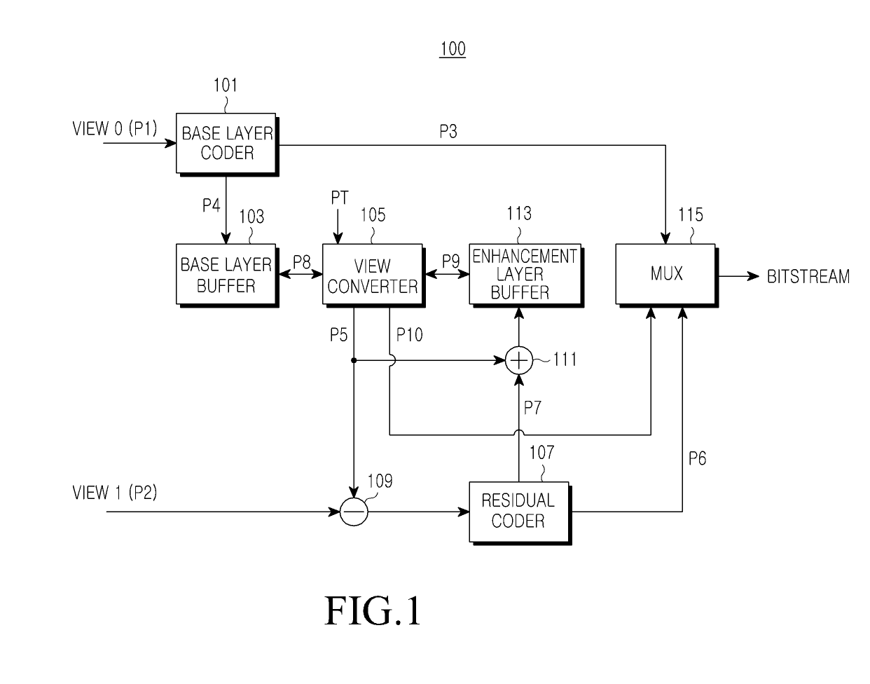

FIG. 1 shows a structure of a multi-view video coder 100 according to an exemplary embodiment. Referring to FIG. 1, P1 represents a base layer's input picture and P2 represents an enhancement layer's input picture. A base layer coder 101 compression-codes the input picture P1 of one view in the base layer according to an existing scheme using an arbitrary video codec among existing video codecs (for example, VC-1, H.264, MPEG-4 Part 2 Visual, MPEG-2 Part 2 Video, AVS, JPEG2000, etc.), and outputs the coded base layer picture in a base layer bitstream P3. Moreover, the base layer coder 101 reconstructs the coded base layer picture, and stores the reconstructed base layer picture P4 in a base layer buffer 103. A view converter 105 receives the currently reconstructed base layer picture (hereinafter, “current base layer picture”) P8 from the base layer buffer 103.

A residual coder 107 receives, through a subtractor 109, picture data obtained by subtracting a prediction picture P5 from the view converter 105 from the enhancement layer's input picture P2, and residual-codes the received picture data. The residual-coded enhancement layer picture, or a coded residual picture, is output in an enhancement layer bitstream P6. The residual coder 107 reconstructs the residual-coded enhancement layer picture, and outputs a reconstructed enhancement layer picture P7, or a reconstructed residual picture. The prediction picture P5 from the view converter 105 and the reconstructed enhancement layer picture P7 are added by an adder 111, and stored in an enhancement layer buffer 113. The view converter 105 receives, from the enhancement layer buffer 113, a previously reconstructed enhancement layer picture (hereinafter, “previous enhancement layer picture”) P9. While the base layer buffer 103 and the enhancement layer buffer 113 are shown separately in the present exemplary embodiment, it is understood that the base layer buffer 103 and the enhancement layer buffer 113 may be implemented in one buffer according to another exemplary embodiment.

The view converter 105 receives the current base layer picture P8 and the previous enhancement layer picture P9 from the base layer buffer 103 and the enhancement layer buffer 113, respectively, and generates the view-converted prediction picture P5. The view converter 105 generates a control information bitstream P10 including the prediction picture's control information, to be described below, which is used for decoding in a multi-view video decoder. The generated prediction picture P5 is output to the subtractor 109 to be used to generate the enhancement layer bitstream P6, and output to the adder 111 to be used to generate the next prediction picture. A multiplexer (MUX) 115 multiplexes the base layer bitstream P3, the enhancement layer bitstream P6, and the control information bitstream P10, and outputs the multiplexed bitstreams P3, P6, P10 in one bitstream.

Due to use of the layered coding structure, the multi-view video coder 100 is compatible with any video coding method, and can be implemented in existing systems and can efficiently support multi-view video services, including 3D video services.

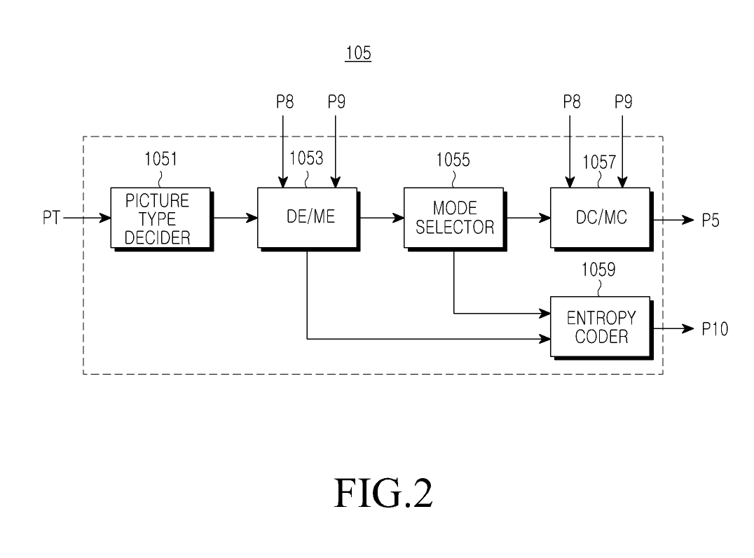

FIG. 2 shows a structure of a view converter 105 in a multi-view video coder 100 according to an exemplary embodiment. Referring to FIG. 2, the view converter 105 divides picture data in units of M×N pixel blocks and sequentially generates a prediction picture block by block. Specifically, a picture type decider 1051 decides whether to use a current base layer picture P8, a currently reconstructed enhancement layer picture (hereinafter, “current enhancement layer picture”) of a view different from that of the base layer, or a combination of the current base layer picture P8 and a previous enhancement layer picture P9 in generating a prediction picture, according to a Picture Type (PT). For example, generating a prediction picture using the current enhancement layer picture may be used when the enhancement layer is plural in number.

The picture type decider 1051 determines a reference relationship, or use, of the current base layer picture P8 and the previous enhancement layer picture P9 according to the PT of the enhancement layer's input picture P2. For example, if a PT of the enhancement layer's input picture P2 to be currently coded is an intra-picture, view conversion for generation of the prediction picture P5 may be performed using the current base layer picture P8. Furthermore, if a plurality of enhancement layers are provided and the PT is an intra-picture, view conversion for generation of the prediction picture P5 may be performed using the current enhancement layer picture.

Also by way of example, if the PT of the enhancement layer's input picture P2 is an inter-picture, view conversion for generation of the prediction picture P5 may be performed using the current base layer picture P8 and the previous enhancement layer picture P9. The PT may be given in an upper layer of the system to which the multi-view video coder of the present exemplary embodiment is applied. The PT may be previously determined as one of the intra-picture or the inter-picture.

Based on the decision results of the picture type decider 1051, a Disparity Estimator/Motion Estimator (DE/ME) 1053 outputs a disparity vector by performing Disparity Estimation (DE) on a block basis using the current base layer picture P8, or outputs a disparity vector and a motion vector of a pertinent block by performing DE and Motion Estimation (ME) on a block basis, respectively, using the current base layer picture P8 and the previous enhancement layer picture P9. If the enhancement layer is plural in number, the DE/ME 1053 may perform DE on a block basis using the current enhancement layer picture in another enhancement layer having a view different from the view of the enhancement layer's input picture.

The disparity vector and the motion vector may be construed to be differently named according to which reference picture(s) is used among the current base layer picture and the previous/current enhancement layer pictures, and a prediction process and a vector outputting process based on the used reference picture(s) may be performed in the same manner.

The view converter 105 performs view conversion in units of macro blocks, or M×N pixel blocks. As an example of the view conversion, the DE/ME 1053 may output at least one of a disparity vector and a motion vector on an M×N pixel block basis. As another example, the DE/ME 1053 may divide each M×N pixel block into K partitions in various methods and output K disparity vectors and/or motion vectors.

For example, if the view converter 105 performs view conversion on a 16×16 pixel block basis, the DE/ME 1053 may output one disparity vector or motion vector in every 16×16 pixel block. As another example, if the view converter 105 divides a 16×16 pixel block into K partitions and performs view conversion thereon, the DE/ME 1053 may selectively output 1K disparity vectors or motion vectors on a 16×16 pixel block basis, or output 4K disparity vectors or motion vectors on an 8×8 pixel block basis.

A mode selector 1055 determines whether to reference the current base layer picture or the previous enhancement layer picture in performing compensation on an M×N pixel block, a prediction picture of which is to be generated. If the enhancement layer is plural in number, the mode selector 1055 determines whether to reference the current enhancement layer picture in performing compensation in another enhancement layer having a view different from that of the enhancement layer.

Based on the result of DE and/or ME performed by the DE/ME 1053, the mode selector 1055 selects an optimal mode from among a DE mode and an ME mode to perform Disparity Compensation (DC) on the current M×N pixel block according to the DE mode using a disparity vector, or to perform Motion Compensation (MC) on the current M×N pixel block according to the ME mode using a motion vector. The mode selector 1055 may divide an M×N pixel block into a plurality of partitions and determine whether to use a plurality of disparity vectors or a plurality of motion vectors. The determined information may be delivered to a multi-view video decoder with the prediction picture's control information to be described later. The number of divided partitions may be determined by default.

A Disparity Compensator/Motion Compensator (DC/MC) 1057 generates a prediction picture P5 by performing DC or MC according to whether a mode with a minimum prediction cost, which is selected in the mode selector 1055, is the DE mode or the ME mode. If the mode selected in the mode selector 1055 is the DE mode, the DC/MC 1057 generates the prediction picture P5 by compensating the M×N pixel block using a disparity vector in the current base layer picture. If the selected mode is the ME mode, the DC/MC 1057 generates the prediction picture P5 by compensating the M×N pixel block using a motion vector in the previous enhancement layer picture. According to an exemplary embodiment, mode information indicating whether the selected mode is the DE mode or the ME mode may be delivered to the multi-view video decoder in the form of flag information, for example.

An entropy coder 1059 entropy-codes the mode information and the prediction picture's control information including disparity vector information or motion vector information, for each block in which a prediction picture is generated, and outputs the coded information in a control information bitstream P10. For example, the control information bitstream P10 may be delivered to the multi-view video decoder after being inserted into a picture header of the enhancement layer bitstream P6. The disparity vector information and the motion vector information in the prediction picture's control information may be inserted into the control information bitstream P10 using the same syntax during entropy coding.

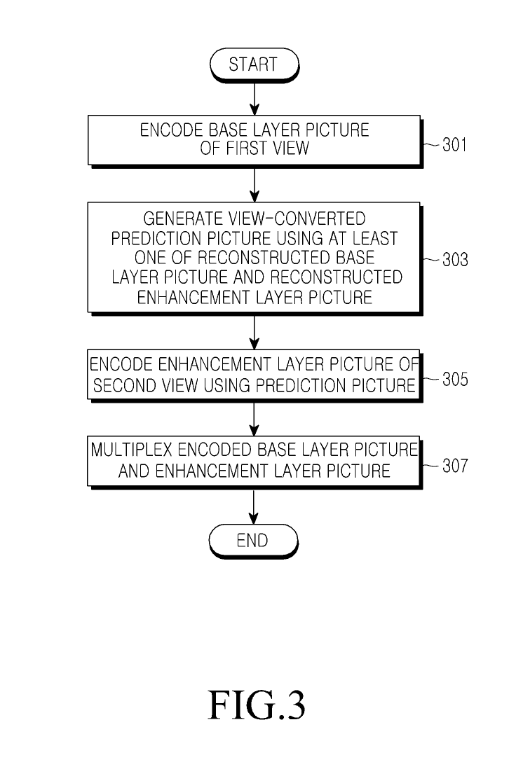

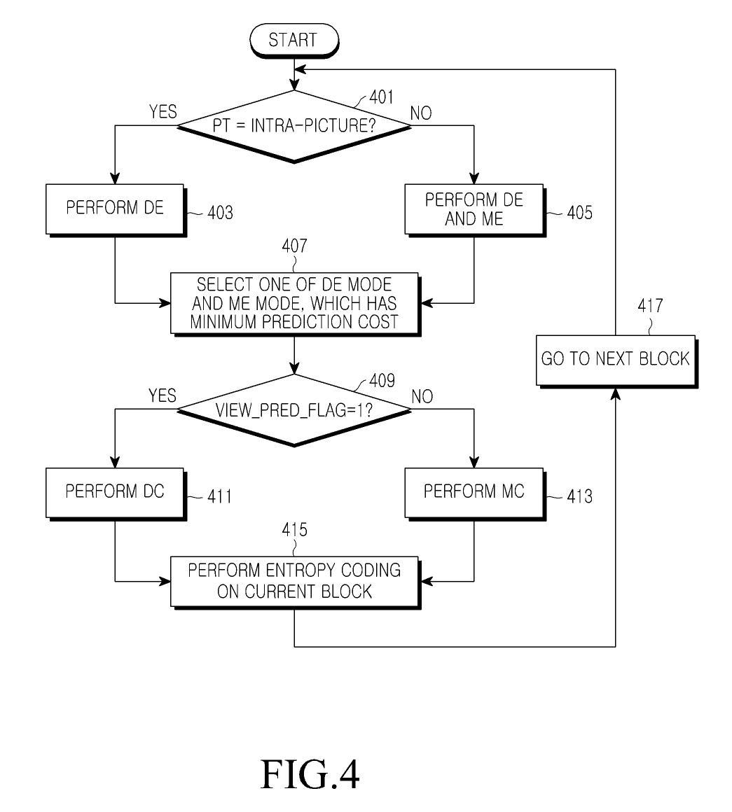

A multi-view video coding method according to one or more exemplary embodiments will now be described with reference to FIGS. 3 and 4.

FIG. 3 shows a multi-view video coding method according to an exemplary embodiment. Referring to FIG. 3, in step 301, a base layer coder 101 outputs a base layer bitstream by coding a base layer's input picture of a first view using a codec. The base layer coder 101 reconstructs the coded base layer picture, and stores the reconstructed base layer picture in a base layer buffer 103. It is assumed that at a prior time, a residual coder 107 residual-coded a previous input picture in an enhancement layer of a second view, reconstructed the coded enhancement layer picture, and output the reconstructed enhancement layer picture. Therefore, the previously reconstructed enhancement layer picture has been stored in an enhancement layer buffer 113 after being added to the prediction picture that was previously generated by the view converter 105.

In step 303, a view converter 105 receives the reconstructed base layer picture and the reconstructed enhancement layer picture from the base layer buffer 103 and the enhancement layer buffer 113, respectively. Thereafter, the view converter 105 generates a prediction picture that is view-converted with respect to an enhancement layer's input picture using at least one of the reconstructed base layer picture and the reconstructed enhancement layer picture. As described above, the view converter 105 may generate the prediction picture using the current base layer picture, or generate the prediction picture using the current base layer picture and the previous enhancement layer picture in the enhancement layer. In step 305, the residual coder 107 residual-codes picture data obtained by subtracting the prediction picture from the enhancement layer's input picture of the second view, and outputs the coded enhancement layer picture.

In step 307, a multiplexer 115 multiplexes the base layer picture coded in step 301 and the enhancement layer picture coded in step 305, and outputs the multiplexed pictures in a bitstream. While the number of the enhancement layers is exemplarily assumed to be one in the example of FIG. 3, the enhancement layer may be plural in number. In this case, as described above, the prediction picture may be generated using the current base layer picture and the previous enhancement layer picture, or the prediction picture may be generated using the current enhancement layer picture in another enhancement layer having a view different from that of the enhancement layer.

While the coding process of the base layer picture and the coding process of the enhancement layer picture are sequentially illustrated in the example of FIG. 3, it is understood that coding of the base layer picture and coding of the enhancement layer picture may be performed in parallel.

FIG. 4 shows a view conversion method performed in a multi-view video coder according to an exemplary embodiment. In the present exemplary embodiment, a macro block processed during generation of a prediction picture is a 16×16 pixel block, though it is understood that this size is merely exemplary and another exemplary embodiment is not limited thereto.

Referring to FIG. 4, in step 401, a picture type decider 1051 decides whether a PT of an input picture to be currently coded in the enhancement layer is an intra-picture or an inter-picture. If the PT is determined as an intra-picture in step 401, a DE/ME 1053 calculates, in step 403, a prediction cost of each pixel block by performing DE on a 16×16 pixel block basis and an 8×8 pixel block basis, using the current base layer picture as a reference picture. If the PT is determined as an inter-picture in step 401, the DE/ME 1053 calculates, in step 405, a prediction cost of each pixel block by performing DE and ME on a 16×16 pixel block basis and an 8×8 pixel block each, using the current base layer picture and the previous enhancement layer picture as reference pictures. The prediction cost calculated in step 403 and 405 refers to a difference between the current input picture block and a block that corresponds to the current input picture block based on a disparity vector or a motion vector. Example of the prediction cost include Sum of Absolute Difference (SAD), Sum of Square Difference (SSD), etc.

In step 407, if the enhancement layer's input picture to be currently coded is an intra-picture, a mode selector 1055 selects, in step 407, the DE mode having a minimum prediction cost by comparing a prediction cost obtained by performing DE on a 16×16 pixel block with a prediction cost obtained by performing DE on an 8×8 pixel block in the 16×16 pixel block. If the enhancement layer's input picture to be currently coded is an inter-picture, the mode selector 1055 determines whether a mode having the minimum prediction cost is the DE mode or the ME mode, by comparing a prediction cost obtained by performing DE on a 16×16 pixel block, a prediction cost obtained by performing DE on an 8×8 pixel block in the 16×16 pixel block, a prediction cost obtained by performing ME on a 16×16 pixel block, and a prediction cost obtained by performing ME on an 8×8 pixel block in the 16×16 pixel block. As a result of the selection, when the mode having the minimum prediction cost is the DE mode, the mode selector 1055 sets flag information “VIEW_PRED_FLAG” to 1. Conversely, when the mode having the minimum prediction cost is the ME mode, the mode selector 1055 sets “VIEW_PRED_FLAG” to 0.

When “VIEW_PRED_FLAG” is determined as “in step 409, a DC/MC 1057 performs DC from the current base layer picture using a disparity vector on a 16×16 pixel block basis or an 8×8 pixel block basis, which was generated by DE, in step 411. If “VIEW_PRED_FLAG” is determined as 0 in step 409, the DC/MC 1057 performs MC from the previous enhancement layer picture using a motion vector on a 16×16 pixel block basis or an 8×8 pixel block basis, which was generated by ME, in step 413. In this manner, “VIEW_PRED_FLAG” may indicate which of the base layer picture and the enhancement layer picture is referenced in a process of generating a prediction picture.

After DC or MC is performed on the block in step 411 or 413, an entropy coder 1059 entropy-codes, in step 415, information about the disparity vector or the motion vector calculated by the DE/ME 1053 and information about the mode selected by the mode selector 1055, and outputs the results in a bitstream. If the enhancement layer's input picture to be currently coded is an inter-picture, the entropy coder 1059 entropy-codes “VIEW_PRED_FLAG” and mode information about use/non-use of the disparity vector or motion vector on a 16×16 pixel block basis or an 8×8 pixel block basis, and performs entropy coding on the disparity vector or motion vector as many times as the number of disparity vectors or motion vectors. The entropy coding on the disparity vector or motion vector is achieved by coding a differential value obtained by subtracting the actual vector value from a prediction value of the disparity vector or motion vector. If the enhancement layer's input picture to be currently coded is an intra-picture, coding of “VIEW_PRED_FLAG” may be omitted since, to guarantee random access, only DC may be used from the base layer's picture because the previous picture cannot be referenced. Although the “VIEW_PRED_FLAG” is not present, the multi-view video decoder may perform DC by checking a header of an enhancement layer bitstream, indicating that the enhancement layer picture is an intra-picture.

If the entropy coding has been completed for one block, the view converter 105 goes to the next block in step 417, and steps 401 to 415 are performed on each block of the enhancement layer's input picture to be currently coded.

A structure and operation of a multi-view video decoder according to an exemplary embodiment will now be described in detail. For convenience of description, the exemplary embodiment described below uses both a reconstructed current base layer picture and a reconstructed previous enhancement layer picture during view conversion, and the number of enhancement layers is 1. However, it is understood that another exemplary embodiment is not limited thereto.

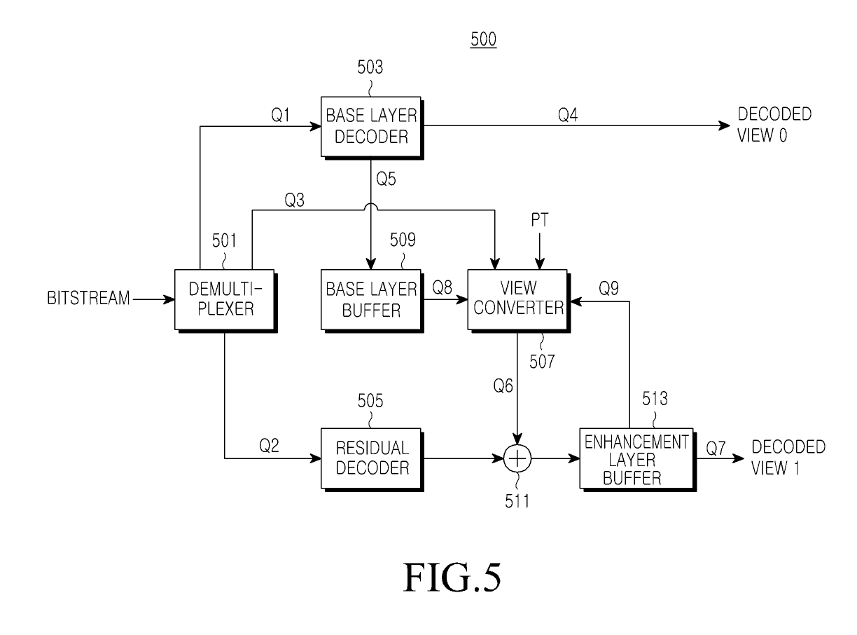

FIG. 5 shows a structure of a multi-view video decoder 500 according to an exemplary embodiment. Referring to FIG. 5, a demultiplexer 501 demultiplexes a bitstream coded by a multi-view video coder 100 into a base layer bitstream Q1, an enhancement layer bitstream Q2, and a control information bitstream Q3 used during decoding of an enhancement layer picture. Furthermore, the demultiplexer 501 provides the base layer bitstream Q1 to a base layer decoder 503, the enhancement layer bitstream Q2 to a residual decoder 505, and the control information bitstream Q3 to a view converter 507.

The base layer decoder 503 outputs a base layer picture Q4 of a first view by decoding the base layer bitstream Q1 using a scheme corresponding to a video codec used in the base layer coder 101. The base layer picture Q4 of the first view is stored in a base layer buffer 509 as a currently reconstructed base layer picture (hereinafter, “current base layer picture”) Q5.

It is assumed that the residual decoder 505 residual-decoded an enhancement layer bitstream Q2 at a previous time, and the enhancement layer picture reconstructed by the residual decoder 505 was added to a prediction picture Q6, which was generated by the view converter 507 at a previous time, using an adder 511 as a combiner, and then stored in an enhancement layer buffer 513. Thus, the view converter 507 receives a previously reconstructed enhancement layer picture (hereinafter, “previous enhancement layer picture”) Q9 from the enhancement layer buffer 513.

While the base layer buffer 509 and the enhancement layer buffer 513 are shown separately in the example of FIG. 5, it is understood that the buffers 509, 513 may be realized in a single buffer according to another exemplary embodiment.

The view converter 507 receives the current base layer picture Q8 and the previous enhancement layer picture Q9 from the base layer buffer 509 and the enhancement layer buffer 513, respectively, and generates a prediction picture Q6 that is view-converted at the present time. The prediction picture Q6 is added to the current enhancement layer picture, which is residual-decoded by the residual decoder 505, using the adder 511, and then output to the enhancement layer buffer 513. The currently reconstructed enhancement layer picture stored in the enhancement layer buffer 513 is output as a reconstructed enhancement layer picture Q7 of a second view. Subsequently, the currently reconstructed enhancement layer picture may be provided to the view converter 507 as the previous enhancement layer picture so as to be used to generate a next prediction picture.

The multi-view video decoder 500 may support the existing 2D video services with one decoded view by decoding only the base layer bitstream. Although only one enhancement layer is shown in the example of FIG. 5, the multi-view video decoder 500 may support multi-view video services if the multi-view video decoder 500 outputs decoded views #1˜N by decoding N enhancement layer bitstreams having different views along with the base layer bitstream. Based on the structure of FIG. 5, the scalability feature for various views may also be provided.

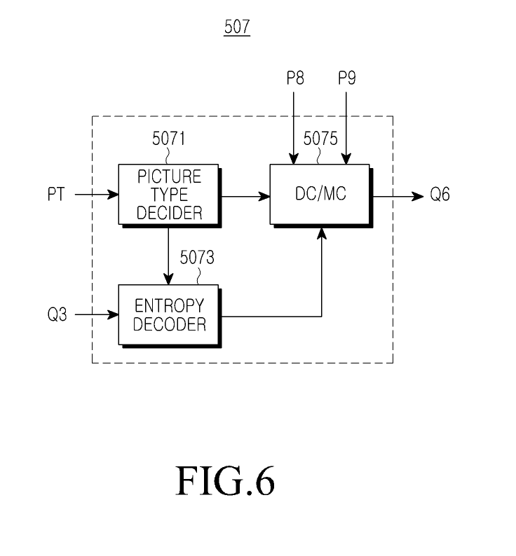

FIG. 6 shows a structure of the view converter 507 in a multi-view video decoder 500 according to an exemplary embodiment. Referring to FIG. 6, the view converter 507 divides picture data in units of M×N pixel blocks, and sequentially generates a prediction picture block by block. Specifically, a picture type decider 5071 decides whether to use a current base layer picture, a currently reconstructed enhancement layer picture (hereinafter, “current enhancement layer picture”) of a different view, or a combination of the current base layer picture and a previous enhancement layer picture in generating a prediction picture, according to the PT. For example, generating a prediction picture using the current enhancement layer picture may be used when the enhancement layer is plural in number.

The PT may be included in header information of the enhancement layer bitstream Q2 input to the residual decoder 505, and may be acquired from the header information by an upper layer of a system to which the multi-view video decoder of the present exemplary embodiment is applied.

The picture type decider 5071 determines a reference relationship, or use, of the current base layer picture Q8 and the previous enhancement layer picture Q9 according to the PT. For example, if a PT of the enhancement layer bitstream Q2 to be currently decoded is an intra-picture, view conversion for generation of the prediction picture Q6 may be performed using only the current base layer picture Q8. Furthermore, if a plurality of enhancement layers are provided and the PT is an intra-picture, view conversion for generation of the prediction picture Q6 may be performed using the current enhancement layer picture.

Also by way of example, if the PT of the enhancement layer bitstream Q2 is an inter-picture, view conversion for generation of the prediction picture Q6 may be performed using the current base layer picture Q8 and the previous enhancement layer picture Q9.

An entropy decoder 5073 entropy-decodes the control information bitstream Q3 received from the demultiplexer 501, and outputs the decoded prediction picture's control information to a DC/MC 5075. As described above, the prediction picture's control information includes mode information and at least one of disparity and motion information corresponding to each of the M×N pixel blocks.

The mode information includes at least one of information indicating whether the DC/MC 5075 will perform DC using a disparity vector or perform MC using a motion vector in the current M×N pixel block, information indicating the number of disparity vectors or motion vectors that the DC/MC 5075 will select in each M×N pixel block, etc.

Based on the prediction picture's control information, if the mode having the minimum prediction cost, selected during coding, is the DC mode, the DC/MC 5075 generates a prediction picture Q6 by performing DC using a disparity vector of the current base layer picture which is identical in time to the enhancement layer's picture to be decoded. Conversely, if the mode having the minimum prediction cost is the MC mode, the DC/MC 5075 generates a prediction picture Q6 by performing MC using a motion vector of the previous enhancement layer picture.

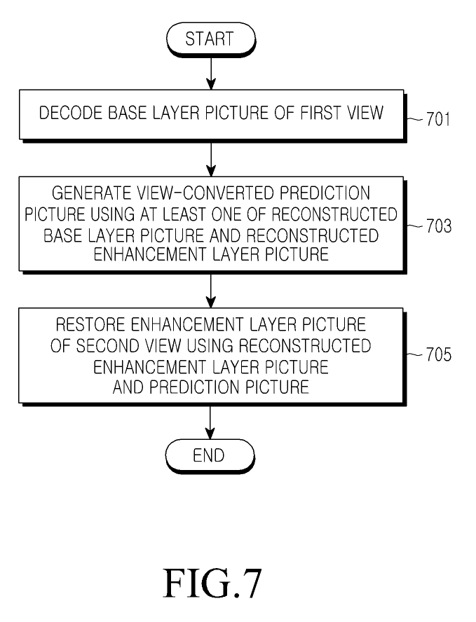

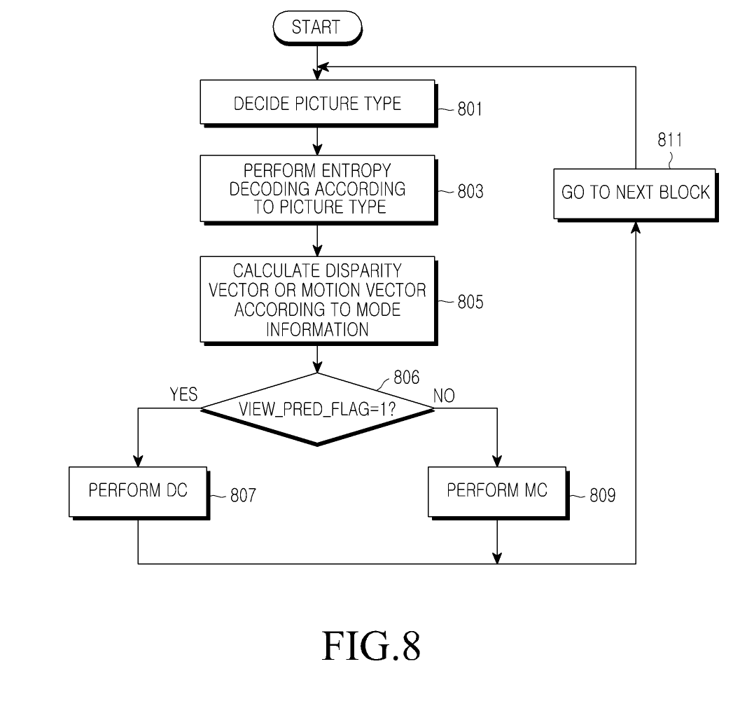

A multi-view video decoding method according to one or more exemplary embodiments will now be described with reference to FIGS. 7 and 8.

FIG. 7 shows a multi-view video decoding method according to an exemplary embodiment. In the present exemplary embodiment, a multi-view video decoder 500 receives a bitstream coded by a multi-view video coder 100 (for example, the multi-view video coder 100 illustrated in FIG. 1). The input bitstream is demultiplexed into a base layer bitstream, an enhancement layer bitstream, and a control information bitstream by the demultiplexer 501.

Referring to FIG. 7, in step 701, a base layer decoder 503 receives the base layer bitstream, and reconstructs a base layer picture of a first view by decoding the base layer bitstream using a scheme corresponding to a codec used in a base layer coder 101 of the multi-view video coder 100. The base layer decoder 503 stores the base layer picture reconstructed by decoding in a base layer buffer 509. A residual decoder 505 receives a current enhancement layer picture and residual-decodes the received current enhancement layer picture. It is assumed that an enhancement layer picture previously reconstructed by residual decoding and a prediction picture previously generated by a view converter 507 were previously added by an adder 511 and stored in an enhancement layer buffer 513 in advance.

In step 703, the view converter 507 receives the reconstructed base layer picture and the reconstructed enhancement layer picture from the base layer buffer 509 and the enhancement layer buffer 513, respectively. The view converter 507 generates a prediction picture which is view-converted with respect to the enhancement layer's input picture using at least one of the reconstructed base layer picture and the reconstructed enhancement layer picture. As described above, the view converter 507 may generate the prediction picture using the current base layer picture, or generate the prediction picture using the current base layer picture and the previous enhancement layer picture in the enhancement layer. In step 705, the adder 511 reconstructs an enhancement layer picture of a second view by adding the prediction picture generated in step 703 to the current enhancement layer picture residual-decoded by the residual decoder 505. The currently reconstructed enhancement layer picture of the second view is stored in the enhancement layer buffer 513, and may be used as a previous enhancement layer picture when a next prediction picture is generated.

While it is assumed in the present exemplary embodiment that the number of enhancement layers is 1, it is understood that the enhancement layer may be plural in number so as to correspond to the number of enhancement layers in the multi-view video coder 100. In this case, as described above, the prediction picture may be generated using the current base layer picture and the previous enhancement layer picture, or the prediction picture may be generated using the current enhancement layer picture in another enhancement layer having a view different from that of the enhancement layer.

Furthermore, while the decoding of the base layer picture and the decoding of the enhancement layer picture are sequentially illustrated in the example of FIG. 7, it is understood that decoding of the base layer picture and decoding of the enhancement layer picture may be performed in parallel.

FIG. 8 shows a view conversion method performed in a multi-view video decoder according to an exemplary embodiment. In the present exemplary embodiment, a macro block processed during generation of a prediction picture is a 16×16 pixel block, though it is understood that this size is merely exemplary and another exemplary embodiment is not limited thereto.

Referring to FIG. 8, in step 801, a picture type decider 5071 determines whether a PT of an enhancement layer's input picture to be currently decoded is an intra-picture or an inter-picture. In step 803, an entropy decoder 5073 performs entropy decoding according to the determined PT. Specifically, when the enhancement layer's picture to be currently decoded is an inter-picture, the entropy decoder 5073 entropy-decodes “VIEW_PRED_FLAG,” mode information about use/non-use of a disparity vector or a motion vector on a 16×16 pixel basis or an 8×8 pixel basis, and prediction picture control information including disparity vector information or motion vector information, for each block, a prediction picture of which is generated from a control information bitstream. If the enhancement layer's picture to be currently decoded is an intra-picture, the entropy decoder 5073 may entropy-decode the remaining prediction picture control information in the same manner, omitting decoding of “VIEW_PRED_FLAG.” The VIEW_PRED_FLAG, decoding of which is omitted, may be set to 1.

In the entropy decoding of step 803, which corresponds to the entropy coding described in step 415 of FIG. 4, the entropy decoder 5073 entropy-decodes mode information about use/non-use of a disparity vector or a motion vector, and performs entropy decoding on the motion vector as many times as the number of disparity vectors or motion vectors. The decoding results on the disparity vectors or motion vectors include a differential value of the disparity vectors or the motion vectors. In step 805, the entropy decoder 5073 generates a disparity vector or a motion vector by adding the differential value to a prediction value of the disparity vector or the motion vector, and outputs the results to a DC/MC 5075.

In step 806, the DC/MC 5075 receives the PT determined in step 801 and the “VIEW_PRED_FLAG” and the disparity vector or motion vector calculated in step 803, and checks a value of “VIEW_PRED_FLAG.”

If “VIEW_PRED_FLAG”=1 in step 806, the MC/DC 5075 performs, in step 807, DC from the current base layer picture using the disparity vector on a 16×16 pixel basis or an 8×8 pixel basis. If “VIEW_PRED_FLAG”=0 in step 806, the MC/DC 5075 performs, in step 809, MC from the previous enhancement layer picture using a motion vector on a 16×16 pixel basis or an 8×8 pixel basis. In this manner, “VIEW_PRED_FLAG” may indicate which of the base layer picture and the enhancement layer picture is referenced in a process of generating a prediction picture.

If the DC or MC has been completed for one block, a view converter 507 goes to the next block in step 811 so that steps 801 to 809 are performed on each block of the enhancement layer's picture to be currently decoded.

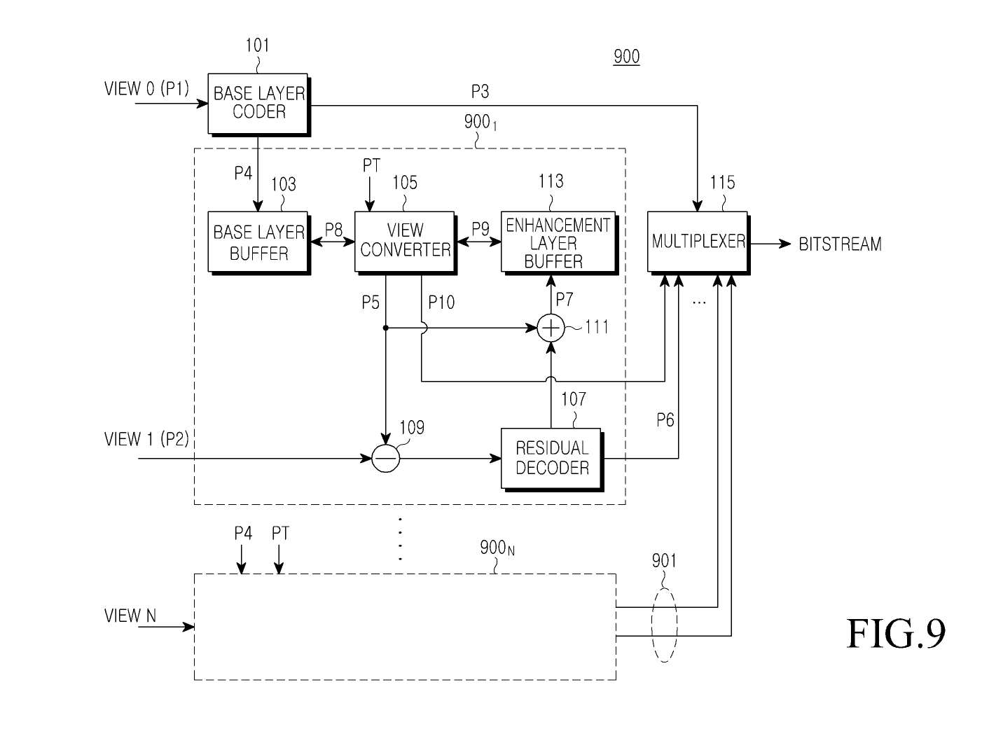

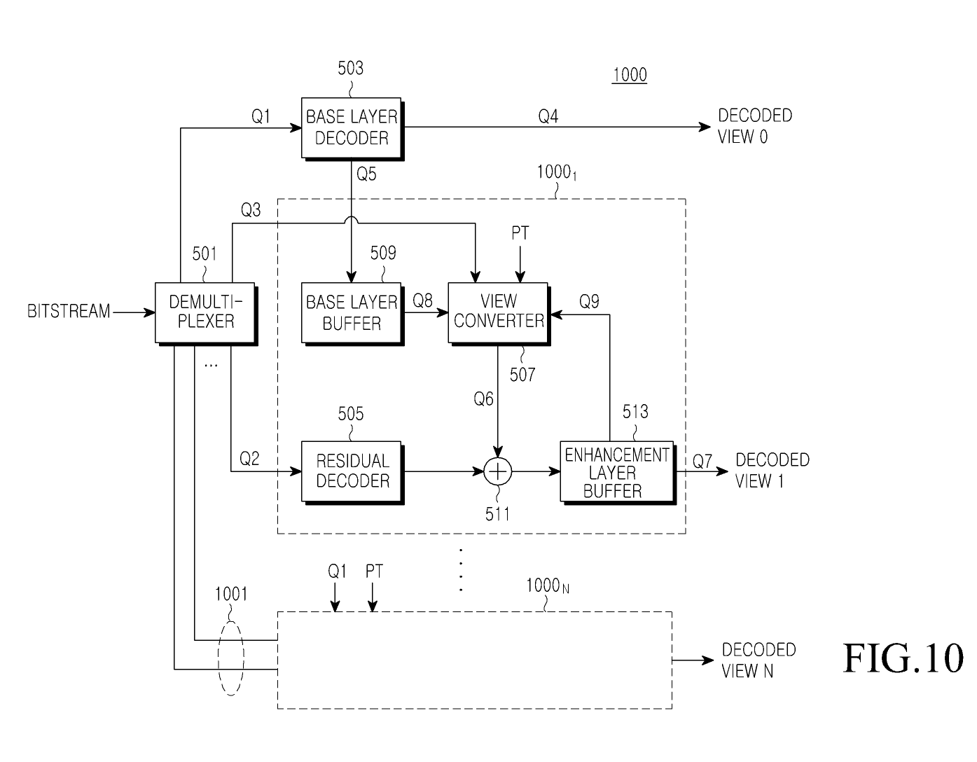

In the foregoing description, the multi-view video coder and decoder having a single enhancement layer have been described by way of example. It is understood that when a multi-view video services having N (where N is a natural number greater than or equal to 3) views is provided, the multi-view video coder and decoder may be extended to have N enhancement layers according to other exemplary embodiments, as shown in FIGS. 9 and 10, respectively.

FIG. 9 shows an exemplary structure of a multi-view video coder 900 with N enhancement layers according to another exemplary embodiment, and FIG. 10 shows an exemplary structure of a multi-view video decoder 1000 with N enhancement layers according to another exemplary embodiment.

Referring to FIG. 9, the multi-view video coder 900 includes first to N-th enhancement layer coding blocks 900₁˜900_{N} corresponding to N enhancement layers. The first to N-th enhancement layer coding blocks 900₁˜900_{N} are the same or similar in structure, and each of the first to N-th enhancement layer coding blocks 900₁˜900_{N} codes its associated enhancement layer's input picture using a view-converted prediction picture according to an exemplary embodiment. Each enhancement layer coding block outputs the above-described control information bitstream and enhancement layer bitstream as coding results, for its associated enhancement layer (901). The enhancement layer coding blocks are the same or similar in structure and operation as those described in FIG. 1, and a detailed description thereof is therefore omitted herein.

Referring to FIG. 10, the multi-view video decoder 1000 includes first to N-th enhancement layer decoding blocks 1000₁˜1000_{N} corresponding to N enhancement layers. The first to N-th enhancement layer decoding blocks 1000₁˜1000_{N} are the same or similar in structure, and each of the first to N-th enhancement layer decoding blocks 1000₁˜1000_{N} decodes its associated enhancement layer bitstream using a view-converted prediction picture according to an exemplary embodiment. Each enhancement layer decoding block receives the above-described control information bitstream and enhancement layer bitstream to decode its associated enhancement layer picture 1001. The enhancement layer decoding blocks are the same or similar in structure and operation as those described in FIG. 5, and a detailed description thereof is therefore omitted herein.

While the multi-view video coder 900 and decoder 1000 of FIGS. 9 and 10 each use a reconstructed base layer picture P4 in each enhancement layer during generation of a prediction picture, it is understood that the multi-view video coder 900 and decoder 1000 may be adapted to use a currently reconstructed enhancement layer picture of a view different from that of the associated enhancement layer, rather than using the reconstructed base layer picture P4 in each enhancement layer during generation of a prediction picture. In this case, the multi-view video coder 900 and decoder 1000 may be adapted to use a currently reconstructed enhancement layer picture in an enhancement layer n−1, replacing the reconstructed base layer picture P4, when generating a prediction picture in an enhancement layer n, or to use the reconstructed picture in each of enhancement layers n−1 and n+1 when generating a prediction picture in an enhancement layer n.

While not restricted thereto, exemplary embodiments can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, exemplary embodiments may be written as computer programs transmitted over a computer-readable transmission medium, such as a carrier wave, and received and implemented in general-use or special-purpose digital computers that execute the programs. Moreover, while not required in all aspects, one or more units of the coder 100, 900 and decoder 500, 1000 can include a processor or microprocessor executing a computer program stored in a computer-readable medium.

While aspects of the inventive concept have been shown and described with reference to certain exemplary embodiments, it will be understood by those skilled in the art that various changes in form and details may be made therein without departing from the spirit and scope of the present inventive concept as defined by the appended claims and their equivalents.

1. A multi-view video coding method for providing a multi-view video service, the multi-view video coding method comprising:
coding a base layer picture using an arbitrary video codec;
generating a prediction picture using at least one of a reconstructed base layer picture, which is reconstructed from the coded base layer picture, and a reconstructed layer picture corresponding to a view different from a view of the base layer picture; and
residual-coding a layer picture corresponding to the different view using the generated prediction picture.

2. The multi-view video coding method of claim 1, wherein the reconstructed layer picture is a previously reconstructed layer picture.

3. The multi-view video coding method of claim 1, wherein the reconstructed layer picture is a currently reconstructed layer picture.

4. The multi-view video coding method of claim 1, wherein the generating the prediction picture comprising generating the prediction picture according to flag information indicating which of the reconstructed base layer picture and the reconstructed layer picture is to be used to generate the prediction picture.

5. The multi-view video coding method of claim 1, wherein the generating the prediction picture comprises:
when the reconstructed base layer picture is used to generate the prediction picture, performing Disparity Compensation (DC) from the reconstructed base layer picture.

6. The multi-view video coding method of claim 1, wherein the generating the prediction picture comprises:
when the reconstructed layer picture is used to generate the prediction picture, performing Motion Compensation (MC) from the reconstructed layer picture.

7. The multi-view video coding method of claim 1, wherein if the multi-view system implements a plurality of layer pictures corresponding to a plurality of different views, a plurality of prediction pictures are generated to correspond to the plurality of layer pictures.

8. The multi-view video coding method of claim 1, wherein the generating the prediction picture comprises generating the prediction picture according to a picture type.

9. The multi-view video coding method of claim 8, wherein the generating the prediction picture according to the picture type comprises:
generating the prediction picture using a disparity vector when the picture type is an intra-picture; and
generating the prediction picture using a motion vector when the picture type is an inter-picture.

10. The multi-view video coding method of claim 1, wherein:
the view of the base layer picture is a left view of a three-dimensional (3D) image and the view of the a layer picture is a right view of the 3D image, or the view of the a layer picture is the right view and the view of the base layer picture is the left view.

11. The multi-view video coding method of claim 1, wherein the residual-coding the layer picture comprises:
obtaining picture data by subtracting the generated prediction picture from the layer picture; and
residual-coding the obtained picture data.

12. A multi-view video coding apparatus for providing a multi-view video service, the multi-view video coding apparatus comprising:
a base layer coder which codes a base layer picture using an arbitrary video codec;
a view converter which generates a prediction picture using at least one of a reconstructed base layer picture, which is reconstructed from the coded base layer picture, and a reconstructed layer picture corresponding to a view different from a view of the base layer picture; and
a residual coder which residual-codes a layer picture corresponding to the different view using the generated prediction picture.

13. The multi-view video coding apparatus of claim 12, wherein the reconstructed layer picture is a previously reconstructed layer picture.

14. The multi-view video coding apparatus of claim 12, wherein the reconstructed layer picture is a currently reconstructed layer picture.

15. The multi-view video coding apparatus of claim 12, wherein the view converter generates the prediction picture according to flag information indicating which of the reconstructed base layer picture and the reconstructed layer picture is to be used to generate the prediction picture.

16. The multi-view video coding apparatus of claim 12, wherein the view converter comprises a disparity compensator which performs Disparity Compensation (DC) from the reconstructed base layer picture, when the reconstructed base layer picture is used to generate the prediction picture.

17. The multi-view video coding apparatus of claim 12, wherein the view converter comprises a motion compensator which performs Motion Compensation (MC) from the reconstructed layer picture, when the reconstructed layer picture is used to generate the prediction picture.

18. The multi-view video coding apparatus of claim 12, wherein if the multi-view system implements a plurality of layer pictures corresponding to a plurality of different views, a plurality of prediction pictures are generated to correspond to the plurality of layer pictures.

19. The multi-view video coding apparatus of claim 12, wherein the view converter generates the prediction picture using a disparity vector when a picture type is an intra-picture, and generates the prediction picture using a motion vector when the picture type is an inter-picture.

20. A multi-view video decoding method for providing a multi-view video service, the multi-view video decoding method comprising:
reconstructing a base layer picture using an arbitrary video codec;
generating a prediction picture using at least one of the reconstructed base layer picture and a reconstructed layer picture corresponding to a view different from a view of the base layer picture; and
reconstructing a layer picture corresponding to the different view using a residual-decoded layer picture and the generated prediction picture.

21. The multi-view video decoding method of claim 20, wherein the reconstructed layer picture is a previously reconstructed layer picture.

22. The multi-view video decoding method of claim 20, wherein the reconstructed layer picture is a currently reconstructed layer picture.

23. The multi-view video decoding method of claim 20, wherein the generating the prediction picture comprises generating the prediction picture according to flag information indicating which of the reconstructed base layer picture and the reconstructed layer picture is to be used to generate the prediction picture.

24. The multi-view video decoding method of claim 20, wherein the generating the prediction picture comprises:
when the reconstructed base layer picture is used to generate the prediction picture, performing Disparity Compensation (DC) from the reconstructed base layer picture.

25. The multi-view video decoding method of claim 20, wherein the generating the prediction picture comprises:
when the reconstructed layer picture is used to generate the prediction picture, performing Motion Compensation (MC) from the reconstructed layer picture.

26. The multi-view video decoding method of claim 20, wherein if the multi-view system implements a plurality of layer pictures corresponding to a plurality of different views, a plurality of prediction pictures are generated to correspond to the plurality of layer pictures.

27. The multi-view video decoding method of claim 20, wherein the generating the prediction picture comprises:
generating the prediction picture using a disparity vector when a picture type is an intra-picture; and
generating the prediction picture using a motion vector when the picture type is an inter-picture.

28. A multi-view video decoding apparatus for providing a multi-view video service, the multi-view video decoding apparatus comprising:
a base layer decoder which reconstructs a base layer picture using an arbitrary video codec;
a view converter which generates a prediction picture using at least one of the reconstructed base layer picture and a reconstructed layer picture corresponding to a view different from a view of the base layer picture;
a residual decoder which residual-decodes a layer picture corresponding to the different view; and
a combiner which reconstructs the layer picture corresponding to the different view by adding the generated prediction picture to the residual-decoded layer picture.

29. The multi-view video decoding apparatus of claim 28, wherein the reconstructed layer picture is a previously reconstructed layer picture.

30. The multi-view video decoding apparatus of claim 28, wherein the reconstructed layer picture is a currently reconstructed layer picture.

31. The multi-view video decoding apparatus of claim 28, wherein the view converter comprises a disparity compensator which performs Disparity Compensation (DC) from the reconstructed base layer picture, when the reconstructed base layer picture is used to generate the prediction picture.

32. The multi-view video decoding apparatus of claim 28, wherein the view converter generates the prediction picture according to flag information indicating which of the reconstructed base layer picture and the reconstructed layer picture is to be used to generate the prediction picture.

33. The multi-view video decoding apparatus of claim 28, wherein the view converter comprises a motion compensator which performs Motion Compensation (MC) from the reconstructed layer picture, when the reconstructed layer picture is used to generate the prediction picture.

34. The multi-view video decoding apparatus of claim 28, wherein if the multi-view system implements a plurality of layer pictures corresponding to a plurality of different views, a plurality of prediction pictures are generated to correspond to the plurality of layer pictures.

35. The multi-view video decoding apparatus of claim 28, wherein the view converter generates the prediction picture using a disparity vector when a picture type is an intra-picture, and generates the prediction picture using a motion vector when the picture type is an inter-picture.

36. A computer readable recording medium having recorded thereon a program executable by a computer for performing the method of claim 1.

37. A computer readable recording medium having recorded thereon a program executable by a computer for performing the method of claim 20.

38. A multi-view video providing system comprising:
a multi-view video coding apparatus, comprising:
a base layer coder which codes a base layer picture using an arbitrary video codec,
a view converter which generates a prediction picture using at least one of a reconstructed base layer picture, which is reconstructed from the coded base layer picture, and a reconstructed layer picture corresponding to a view different from a view of the base layer picture,
a residual coder which residual-codes a layer picture corresponding to the different view using the generated prediction picture, and
a multiplexer which multiplexes the coded base layer picture and the residual-coded layer picture into a bitstream, and outputs the bitstream; and
a multi-view video decoding apparatus comprising:
a demultiplexer which receives and demultiplexes the output bitstream into a base layer bitstream and a layer bitstream,
a base layer decoder which reconstructs the base layer picture from the base layer bitstream using a video codec corresponding to the arbitrary video codec,
a view converter which generates the prediction picture using at least one of the reconstructed base layer picture and the reconstructed layer picture corresponding to the different view,
a residual decoder which residual-decodes the layer bitstream to output a residual-decoded layer picture, and
a combiner which reconstructs the layer picture corresponding to the different view by adding the generated prediction picture to the residual-decoded layer picture.
